(19) United States
(12) Patent Application Publication
(10) Pub. No.: US 2026/0195680 A1
(43) Pub. Date: Jul. 9, 2026

(54) SYSTEMS AND METHODS FOR OPTIMIZING WORKFLOWS WITH SPECIALIZED AI AGENTS IN INDUSTRY-SPECIFIC ENVIRONMENTS

(71) Applicant: SupplyWhy.AI Inc., San Francisco, CA (US)

(72) Inventors: Gaurav Palta, San Francisco, CA (US); Brian Trent, San Francisco, CA (US); Minhaaj Khan, San Francisco, CA (US); Gaurav Sheoran, San Francisco, CA (US)

(21) Appl. No.: 19/433,407

(22) Filed: Dec. 26, 2025

Related U.S. Application Data
(60) Provisional application No. 63/742,102, filed on Jan. 6, 2025.

(51) Int. Cl. G06Q 10/0631; G06Q 10/087

(52) U.S. Cl. CPC G06Q 10/06316; G06Q 10/087

(57) ABSTRACT

The Verticalized Agentic Routines (VARs) system is designed to optimize workflows in various industries by integrating industry data sources to provide accurate and context-aware insights. The system includes a VAR data component that enables semantic understanding and relationship mapping, delivering improved prediction accuracy over industry-specific baselines. Additionally, a VAR AI agent optimizes workflows by providing advanced visibility, actionable insights, and automated response mechanisms. The system also features a VAR collaboration tool that allows non-technical users to build, share, refine, and scale industry-specific routines, ensuring adaptability, scalability, and high performance across multi-tier supply chain entities.

### CROSS-REFERENCE

This non-provisional patent application claims the benefit of priority under 35 U.S.C. § 119(e) to U.S. Provisional Patent Application No. 63/742,102, filed on Jan. 6, 2025, the entire disclosure of which is hereby incorporated by reference.

### TECHNICAL FIELD

The present disclosure relates to a framework for optimizing workflows within specific industries using Verticalized Agentic Routines (VARs) that incorporate artificial intelligence (AI) and machine learning (ML) technologies and large language model (LLM) embeddings.

### BACKGROUND

In today's rapidly evolving technological landscape, industries are increasingly seeking ways to enhance operational efficiency and adaptability. The integration of artificial intelligence (AI) and machine learning (ML) into business processes has become a focal point for innovation, particularly in sectors with complex supply chains and dynamic operational environments. Traditional supply chain management systems, while robust, often lack the flexibility and intelligence required to fully leverage the vast amounts of data generated in real-time. This has led to a growing demand for solutions that not only process data but also provide actionable insights and automated responses.

The challenge lies in creating systems that can seamlessly integrate with existing enterprise infrastructures while offering advanced capabilities such as predictive analytics, anomaly detection, and real-time monitoring. Moreover, there is a need for tools that empower non-technical users to harness these advanced technologies without requiring deep technical expertise. As industries become more interconnected, the ability to facilitate secure and efficient communication across multi-tier supply chain entities becomes crucial. This context underscores the necessity for innovative frameworks that can address these challenges, providing scalable and adaptable solutions that drive industry-leading performance.

### SUMMARY

The inventive concepts disclosed herein involve a computer-implemented approach for optimizing workflows in a specific industry using Verticalized Agentic Routines (VARs). VARs refer to specialized AI agents or Agentic AI that are tailored to perform specific tasks within distinct industries or sectors efficiently and accurately. Unlike traditional AI models that perform tasks such as generating text upon being prompted by an input, the agentic AI are goal-driven software entities that use AI techniques to complete tasks and achieve goals. Agentic AI don't require explicit inputs and don't produce predetermined outputs. Instead, they can receive instructions, create a plan and use tooling to complete tasks, and produce dynamic outputs. As such, these vertical AI tools can significantly enhance operational effectiveness by focusing on niche functionalities, allowing for more precise coordination across various workflows.

The VAR data component can integrate multiple industry data sources to ensure accurate and context-aware insights. The VAR data component may also enable semantic understanding and relationship mapping of the integrated industry data sources. The VAR data component can deliver improved prediction accuracy compared to industry-specific baseline forecasts. The VAR AI agent may optimize industry workflows based on the accurate and context-aware insights provided by the VAR data component. The VAR AI agent can enable advanced visibility, actionable insights, and automated response mechanisms for the optimized industry workflows. The systems and methods may ensure adaptability, scalability, and industry-leading performance of the optimized industry workflows.

The VAR data component may leverage proprietary data models, knowledge graphs, AI/ML based predictions, and large language model (LLM) embeddings. The AI/ML based predictions may generate outputs that are leveraged by the VAR AI agent to perform adjustments mimicking human behavior.

The AI/ML based predictions can generate outputs that are leveraged by the VAR AI agent to perform adjustments mimicking human behavior.

The VAR data component may enhance the ability of the VAR AI agent to process and understand natural language inputs, including instructions, queries, and unstructured data. Thereby, improving efficiency, performance, and decision-making for the optimized industry workflows.

Additionally, the inventive concepts disclose a VAR collaboration tool can allow non-technical users to build, share, refine, and scale industry-specific routines. The VAR collaboration tool may enable seamless communication and coordination across multi-tier supply chain entities; ensuring adaptability, scalability, and industry-leading performance of the optimized industry workflows. The VAR collaboration tool may foster collaboration, improve supply chain efficiency, and enhance network harmonization and performance.

The VAR collaboration tool may include an Agentic Routine Builder, which is a user-friendly tool for building, sharing, refining, and scaling industry-specific routines.

The VAR collaboration tool may also include an agent-to-agent collaboration framework that uses shared context, hierarchical planning, and chain of thought, and is proprietary and secure. The VAR collaboration tool can foster collaboration, improve supply chain efficiency, and enhance network harmonization and performance.

The VAR system may optimize workflows in at least some examples of the following industries, for example, supply chain, automotive, manufacturing, or logistics.

The VAR AI agent can enable at least some examples of real-time monitoring, predictive analytics, anomaly detection, or automated routine workflows for the optimized industry workflows.

Vertical AI agents are specialized artificial intelligence systems designed for specific industries or applications, contrasting with horizontal AI agents, which focus on broader tasks applicable across multiple domains. Some advantages of vertical AI agents include—domain expertise by being tailored to specific fields (e.g., healthcare, finance, or manufacturing) that allows them to understand context, terminology, and best practices to enhance expertise that can lead to more accurate and relevant insights; improved efficiency by automating repetitive tasks that leads to faster decision-making and reduced operational costs; and higher accuracy in tasks such as predictive analytics, optimization and diagnosis.

Additional advantages of vertical AI agents includes, better use experience that align closely with the needs of specific industries that enhances user experience and adoption rates among professionals who may not be tech savvy; regulatory compliance by incorporating necessary compliance measures directed into the workflow for industries like finance and healthcare; scalability by accommodating the specific needs of an industry; cost effectiveness by automating niche tasks, reducing labor costs and minimizing errors; tailored insights to specific market trends; and integration with existing software and systems used within target industries, facilitating easier implementation and reducing disruption.

### BRIEF DESCRIPTION OF THE DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures are listed below.

FIG. 1 illustrates a Verticalized Agentic Routines (VAR) system that converts data into knowledge and learning, using structured and unstructured data, third-party inputs, and IP assets.

FIG. 2 illustrates another representation of the VAR system shown in FIG. 1.

FIG. 3 shows a system for Agent Assisted Planning Orchestration, enhancing plan accuracy and efficiency through data integration and user-friendly interfaces.

FIG. 4 illustrates optimizing industry workflows using the VAR system for enhanced insights and performance.

FIG. 5 illustrates components and connections within a Verticalized Agentic Routines (VARs) System.

FIG. 6 illustrates a block diagram of a plurality of VAR systems connected to a Centralized Self Learning System.

It should be clear that the description of the embodiments and attached figures set forth in this specification serves only for a better understanding, without limiting scope. It should also be clear that a person skilled in the art, after reading the present specification could make adjustments or amendments to the attached figures and above described embodiments that would still be covered by the present disclosure.

### DETAILED DESCRIPTION

The present disclosure is not limited to particular systems, which may, of course, vary. It is also to be understood that the terminology used herein is for the purpose of describing particular embodiments only and is not intended to be limiting. Unless defined otherwise, all technical and scientific terms used herein have the same meaning as commonly understood by one of ordinary skill in the art.

The present disclosure can be understood more readily by reference to the instant detailed description, examples, and claims. It is to be understood that this disclosure is not limited to the specific systems, devices, and/or methods disclosed unless otherwise specified, as such can, of course, vary. It is also to be understood that the terminology used herein is for the purpose of describing particular aspects only and is not intended to be limiting.

The instant description is provided as an enabling teaching of the disclosure in its best, currently known aspect. Those skilled in the relevant art will recognize that many changes can be made to the aspects described, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the instant description is provided as illustrative of the principles of the present disclosure and not in limitation thereof.

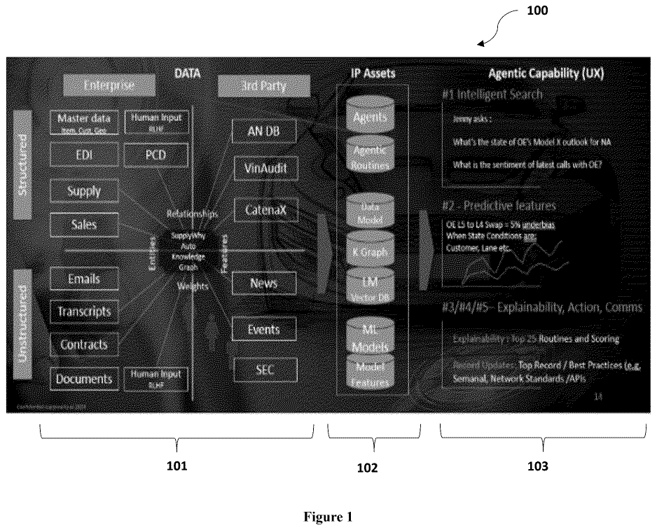

The disclosure provides a system and method for optimizing workflows in specific industries using a framework known as Verticalized Agentic Routines (VARs). As illustrated in FIG. 1, the VAR system 100 may include a VAR data component 101, IP Assets 102, and agentic capabilities 103.

FIG. 1 presents a comprehensive VAR system 100 designed to transform data into knowledge and learning, thereby enhancing user experience through intelligent search and predictive features. This system 100 integrates structured and unstructured data sources and third-party data sources (collectively, data 101) with IP assets 102 such as agents and agentic routines. The system 100 leverages knowledge graph and machine learning models under the IP assets 102 to provide explainability, action, and communication capabilities 103, aligning with the system's objectives regarding the optimization of workflows using Verticalized Agentic Routines (VARs).

The VAR data component 101 may integrate a variety of industry data sources to ensure accurate and context-aware insights. This component can enable semantic understanding and relationship mapping, delivering improved prediction accuracy compared to industry-specific baseline forecasts. As illustrated, VAR data component 101 is divided into enterprise data and external, third-party data. And, furthermore, such data is categorized as either structured or unstructured. Structured data under enterprise includes master data, electronic data interchange (EDI), supply or inventory, sales, production control department (PCD) and inputs by a user. Whereas, unstructured data under enterprise includes, emails, transcripts, contracts, documents attached to emails, and inputs by a user.

Similarly, data from external third-party vendors also includes structured and unstructured data. Structured data includes data from various data service providers; and unstructured data includes news, events happening globally or regionally, and reports or findings issued by the U.S. Securities and Exchange Commission. These data inputs are processed through a knowledge graph, which facilitates semantic understanding and relationship mapping, crucial for the VAR data component's role in delivering accurate and context-aware insights.

Next, the VAR data component 101 is analyzed by the IP Assets 102 that may leverage proprietary data models, knowledge graphs, AI/ML-based predictions, and large language model embeddings to enhance the ability of the VAR AI agent to process and understand natural language inputs, including instructions, queries, and unstructured data.

For example, proprietary data models may integrate a wide range of data sources, including domain-specific datasets (both structured and unstructured), real-time operational data, application-generated data, and both public and private third-party data. This comprehensive approach ensures accurate and context-aware insights tailored to specific industry needs.

Knowledge Graphs include dynamic, interconnected representations of domain knowledge that enable semantic understanding and relationship mapping. These knowledge graphs include specific entities, relationships, features, and model weights, empowering AI agents to infer, reason, and act efficiently. Machine Learning Predictive Models are trained with proprietary features derived from supply chain network participant behavior, that deliver improved accuracy against Industry specific baseline forecasts (e.g. EDI 830). EDI 830, for example, is a transaction code used to communicate forecasted demand from buyers to suppliers. It acts as a planning schedule that includes both short-term and long-term demand projections, serving as an electronic sales forecast for manufacturers. The models' probabilistic and simulated outputs are leveraged by AI Agents to act and perform adjustments that mimic human behavior (e.g., modifying a production plan or schedule). The models and proprietary features capture the unique behavior of Electronic Data Interchange (EDI 830) amongst Automotive supply chain participants. And, large language model (LLM) embeddings are pretrained and fine-tuned embeddings that are optimized for specific verticals, enhancing the ability of agents to process and understand natural language instructions, queries, and unstructured data. Custom LLM training pipelines further refine the LLMs' understanding of niche terminologies and workflows within each industry

Still referring to FIG. 1, the IP Assets 102 include The VAR AI agent and agentic routines that may optimize industry workflows based on these insights, providing advanced visibility, actionable insights, and automated response mechanisms. Thereby, providing a comprehensive approach that improves adaptability, efficiency, scalability, performance, and decision-making for optimized industry workflows. The IP assets 102 enable the system to perform intelligent search and predictive analytics, as indicated by the agentic capability (UX) section 103. The agentic capability 103 outlines features like intelligent search, predictive features, and explainability, which are integral to the VAR AI agent's ability to optimize industry workflows and provide actionable insights.

Agentic routines are modular, task-specific workflows designed for automation and optimization within specific industry verticals. Each routine represents a sequence of operations that an AI agent can execute semi-autonomously (driver-assist) or autonomously (fully automated). The agentic routines are optimized using ML techniques such as reinforcement learning and gradient-based optimization that are employed to continually improve routine efficiency and outcomes. However, supervisory controls are in place such that human-in-the-loop frameworks allow for real-time oversight, validation, and intervention, ensuring compliance, accuracy, and safety.

The IP Assets 102 may also include an agentic routine builder, a VAR collaboration tool, that is an intuitive tool that empowers non-technical users to create, share, refine, and modify agentic routines without requiring technical expertise. The platform allows users to collaborate, share routines with the user community, and contribute to a growing library of industry-specific workflows. Thereby, fostering collaboration and improving supply chain efficiency.

The VAR system 100 also promotes agent-to-agent collaboration. That is, a proprietary and secure agent-to-agent collaboration framework enables seamless communication and coordination across multi-tier supply chain entities using shared context, hierarchical planning and chain of thought to achieve complex goals. This facilitates improved network harmonization and performance. For example, in the automotive industry, this capability can be leveraged to optimize interactions between suppliers and original equipment manufacturers (OEMs), particularly in specialized segments like electric vehicles.

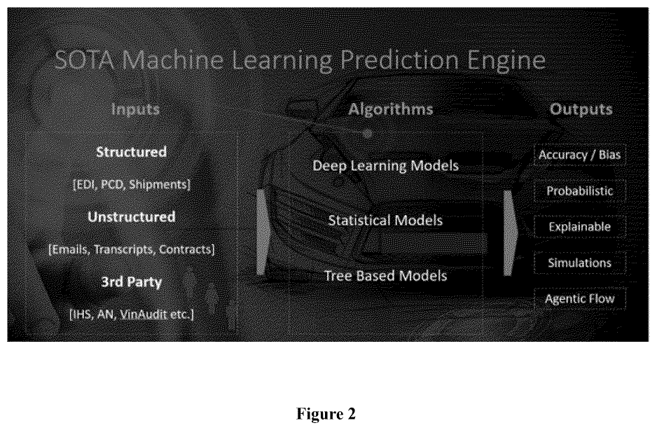

Next, referring to FIG. 2, which illustrates another representation of the VAR system shown in FIG. 1. A state-of-the art (SOTA) Machine Learning Prediction Engine, which processes various data inputs using deep learning, statistical, and tree-based models. The inputs include structured data (EDI, PCD, shipments), unstructured data (emails, transcripts, contracts), and third-party data (IHS, AN, VinAudit, etc.), similar to as discussed under FIG. 1. The outputs of this engine are designed to be accurate, probabilistic, explainable, and capable of simulations and agentic flow, supporting the VAR system's goal of improving prediction accuracy and enabling automated response mechanisms. As discussed above, Machine Learning Models are trained with Proprietary Features derived from supply chain network participant behavior, that deliver improved accuracy against Industry specific baseline forecasts (e.g. EDI 830). Importantly, the models' probabilistic and simulated outputs are leveraged by AI Agents to act and perform adjustments that mimic human behavior (e.g., modifying a production plan or schedule). The models and proprietary features capture the unique behavior of Electronic Data Interchange (EDI 830) amongst Automotive supply chain participants while also leveraging information from unstructured data sources.

Overall, FIG. 2 illustrates the integration and processing of diverse data sources to enhance the VAR system's capabilities, ensuring adaptability, scalability, and high performance in optimizing workflows across various industries. The interaction between data inputs 101 and IP assets 102, such as machine learning models and agentic AI, highlights the VAR system's 100 ability to deliver advanced visibility and actionable insights.

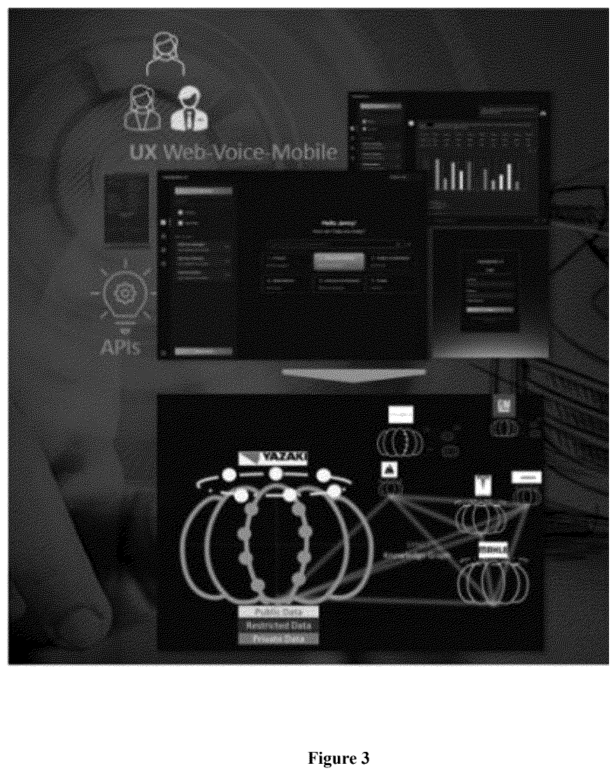

Referring now to FIG. 3, the illustration depicts a user interface for Agent Assisted Planning Orchestration, enhancing plan accuracy and efficiency. The user interface illustrated in FIG. 3 can be implemented on any computer implemented device such as computers, smart phones, tablets, and the like. This system is designed to enhance plan accuracy, OTIF (On-Time In-Full), inventory, and EBIT (Earnings Before Interest and Taxes) within the automotive industry. The figure highlights the integration of various data types, including public, restricted, and private data, into a comprehensive knowledge graph, specifically the STMicro Knowledge Graph. This integration is crucial for providing accurate and context-aware insights. FIG. 3 illustrates an agent-to-agent collaboration. Wherein, a proprietary and secure agent-to-agent collaboration framework enables seamless communication and coordination across multi-tier supply chain entities using shared context, hierarchical planning and chain of thought to achieve complex goals. This facilitates improved network harmonization and performance. For example, in the automotive industry, this capability can be leveraged to optimize interactions between suppliers and original equipment manufacturers (OEMs), particularly in specialized segments like electric vehicles.

The image showcases a user-friendly interface that supports web, voice, and mobile platforms, emphasizing accessibility and ease of use for non-technical users. This aligns with the system's focus on enabling non-technical users to build, share, refine, and scale industry-specific routines through the Agentic Routine Builder. The presence of APIs further supports seamless integration with existing enterprise systems, minimizing latency and errors in executing actions based on insights generated by the system.

FIG. 3 also illustrates the involvement of key industry players to which the VAR is targeted towards. For example, in the automotive industry, different industry players such as YAZAKI, GM, Tesla, and MAHLE, indicating a partnership program that leverages the VARs system's capabilities to improve supply chain efficiency and network harmonization. Such collaboration framework between different agents and industry players enables seamless communication and coordination across multi-tier supply chain entities. The depiction of these elements underscores the system's adaptability, scalability, and high performance. Industry players related to automotive industry is shown as an example. One skilled in the artisan would appreciate that industry players from different industries may be implemented for collaboration purposes. A skilled artisan would appreciate that automotive industry leaders shown in FIG. 3 are exemplars, and other industry leaders related to the automotive industry may be involved in the agent-to-agent collaboration. Or, alternatively, different industry leaders in a different industry may be involved in such collaboration, such as those related to healthcare, tourism, and consumer goods industry.

Overall, FIG. 3 effectively demonstrates how the VAR system integrates advanced data processing and user-friendly interfaces to optimize workflows in a given industry. The system's ability to transform data into actionable insights through a knowledge graph and its support for various user platforms highlight its potential to enhance operational efficiency and decision-making processes.

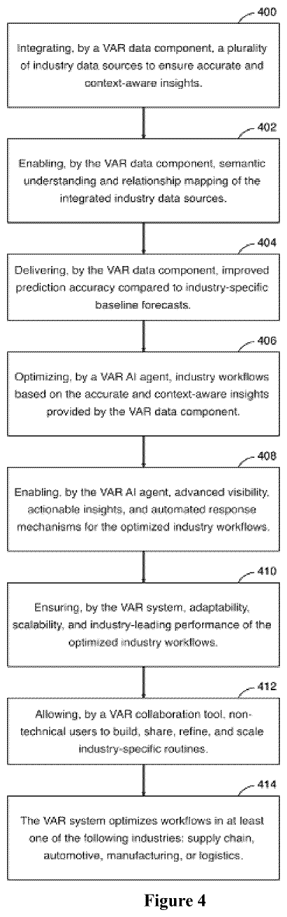

FIG. 4 is a flowchart illustrating a method for optimizing workflows in a specific industry using a Verticalized Agentic Routines (VARs) system, according to an embodiment. At step 400, the VAR data component may integrate a plurality of industry data sources to ensure accurate and context-aware insights. This integration may involve the use of proprietary data models and knowledge graphs, which can facilitate the semantic understanding and relationship mapping of the integrated industry data sources. The VAR data component may leverage AI/ML based predictions and large language model (LLM) embeddings to enhance its capabilities. The delivery of improved prediction accuracy compared to industry-specific baseline forecasts may be achieved by the VAR data component through the use of machine learning predictive models. These models may generate outputs that are leveraged by the VAR AI agent to perform adjustments mimicking human behavior. The VAR AI agent may optimize industry workflows based on the accurate and context-aware insights provided by the VAR data component. This optimization may improve efficiency, performance, and decision-making for the optimized industry workflows. The VAR AI agent may enable advanced visibility, actionable insights, and automated response mechanisms for the optimized industry workflows. This may include real-time monitoring, predictive analytics, anomaly detection, or automated routine workflows. The VAR system may ensure adaptability, scalability, and high performance of the optimized industry workflows. The VAR collaboration tool may allow non-technical users to build, share, refine, and scale industry-specific routines. The Agentic Routine Builder, a user-friendly tool, may facilitate this process. The agent-to-agent collaboration framework may use shared context, hierarchical planning, and chain of thought to enable seamless communication and coordination across multi-tier supply chain entities. This may foster collaboration, improve supply chain efficiency, and enhance network harmonization and performance. The VAR system may optimize workflows in at least one of the following industries: supply chain, automotive, manufacturing, or logistics.

In step 402, the VAR data component may enable semantic understanding and relationship mapping of the integrated industry data sources. This process may involve leveraging knowledge graphs, which can facilitate the semantic understanding necessary for mapping relationships within the data. The VAR data component 101 may utilize proprietary data models, knowledge graphs, AI/ML based predictions, and large language model (LLM), as shown under IP Assets 102, embeddings to achieve this. These elements may work together to enhance the VAR system's 100 ability to process and understand complex data structures, thereby enabling more accurate and context-aware insights. The knowledge graphs may serve as a foundational element, allowing the VAR data component 101 to infer and reason about the data, which can lead to improved decision-making capabilities. This step optimizes workflows within specific industries, as it may provide the necessary context and understanding to inform the actions of the VAR AI agent. The integration of these advanced technologies may ensure that the VAR system 101 can adapt to various industry needs, providing a scalable and high-performance solution for workflow optimization.

In the context of step 404, the VAR data component may deliver improved prediction accuracy compared to industry-specific baseline forecasts. This process may involve the utilization of Machine Learning Predictive Models, which are designed to enhance the accuracy of predictions by leveraging AI/ML based predictions. These predictions may generate outputs that are leveraged by the VAR AI agent to perform adjustments that mimic human behavior. The VAR AI agent may utilize these outputs to optimize workflows, thereby improving efficiency, performance, and decision-making for the optimized industry workflows. The integration of these predictive models may allow the VAR system to provide accurate and context-aware insights, which are crucial for the optimization of industry workflows. The VAR data component may employ proprietary data models, knowledge graphs, and large language model (LLM) embeddings to ensure that the insights are both accurate and context-aware. This integration may enable the VAR AI agent to process and understand natural language inputs, including instructions, queries, and unstructured data, thereby enhancing the overall capability of the system. The VAR system may ensure adaptability, scalability, and high performance of the optimized industry workflows, which may be achieved through the continuous refinement of agentic routines and the incorporation of advanced optimization techniques. The system may also facilitate seamless communication and coordination across multi-tier supply chain entities, thereby improving network harmonization and performance.

In the context of optimizing industry workflows, as reflected in step 406, the VAR AI agent may play a role by utilizing accurate and context-aware insights provided by the VAR data component. This process may involve the AI agent leveraging these insights to enhance the efficiency, performance, and decision-making capabilities of the workflows. The VAR AI agent may employ advanced techniques to ensure that the workflows are optimized to meet industry-specific requirements.

In the context of step 408, the VAR AI agent may enable advanced visibility, actionable insights, and automated response mechanisms for optimized industry workflows. This step may involve the VAR AI agent facilitating real-time monitoring, predictive analytics, anomaly detection, and automated routine workflows. The VAR AI agent may utilize AI/ML-based predictions to generate outputs that can be leveraged to perform adjustments mimicking human behavior.

In step 410, the VAR system 100 may ensure adaptability, scalability, and high performance of the optimized industry workflows. The VAR system 100, which may include components such as proprietary data models, knowledge graphs, AI/ML based predictions, and large language model (LLM) embeddings, may be designed to integrate a wide range of data sources. This integration may provide accurate and context-aware insights tailored to specific industry needs. The adaptability of the VAR system may be facilitated by its ability to leverage these data models and knowledge graphs, enabling semantic understanding and relationship mapping. This capability may empower AI agents to infer, reason, and act efficiently, thereby optimizing workflows within specific industries. The scalability of the system may be supported by the modular design of agentic routines, which are task-specific workflows that can be executed semi-autonomously or autonomously by AI agents. The VAR system may also employ optimization techniques and supervisory controls to ensure that the workflows are not only optimized but also adaptable to dynamic operational environments.

At step 412, the VAR collaboration tool may allow non-technical users to build, share, refine, and scale industry-specific routines. This process may be facilitated by the Agentic Routine Builder, which is designed as a user-friendly tool to support these activities. The Agentic Routine Builder may empower users by providing an intuitive interface that simplifies the creation and management of routines, potentially enhancing user collaboration and routine development. Additionally, the agent-to-agent collaboration framework may be employed to use shared context, hierarchical planning, and chain of thought, which may enable seamless communication and coordination across multi-tier supply chain entities. This framework may contribute to improved network harmonization and performance by fostering collaboration and enhancing supply chain efficiency. The VAR collaboration tool, through these mechanisms, may support the overall goal of optimizing workflows and improving performance within specific industries.

In step 414, the VAR system 100 may optimize workflows within specific industries such as supply chain, automotive, manufacturing, or logistics, for example. This optimization may be achieved through the integration of various components and techniques that are part of the Verticalized Agentic Routines (VARs) framework. The VAR system may leverage proprietary data models, knowledge graphs, AI/ML based predictions, and large language model (LLM) embeddings to provide accurate and context-aware insights. These insights may be used by AI agents to optimize industry workflows, enabling advanced visibility, actionable insights, and automated response mechanisms. The system may ensure adaptability, scalability, and high performance by employing optimization techniques and supervisory controls.

The VAR system may also facilitate seamless communication and coordination across multi-tier supply chain entities through an agent-to-agent collaboration framework. This framework may use shared context, hierarchical planning, and chain of thought to achieve complex goals, thereby improving network harmonization and performance. Additionally, the VAR system may allow non-technical users to build, share, refine, and scale industry-specific routines using the Agentic Routine Builder, fostering collaboration and improving supply chain efficiency. Through these capabilities, the VAR system may enhance decision-making, efficiency, and performance in the optimized industry workflows.

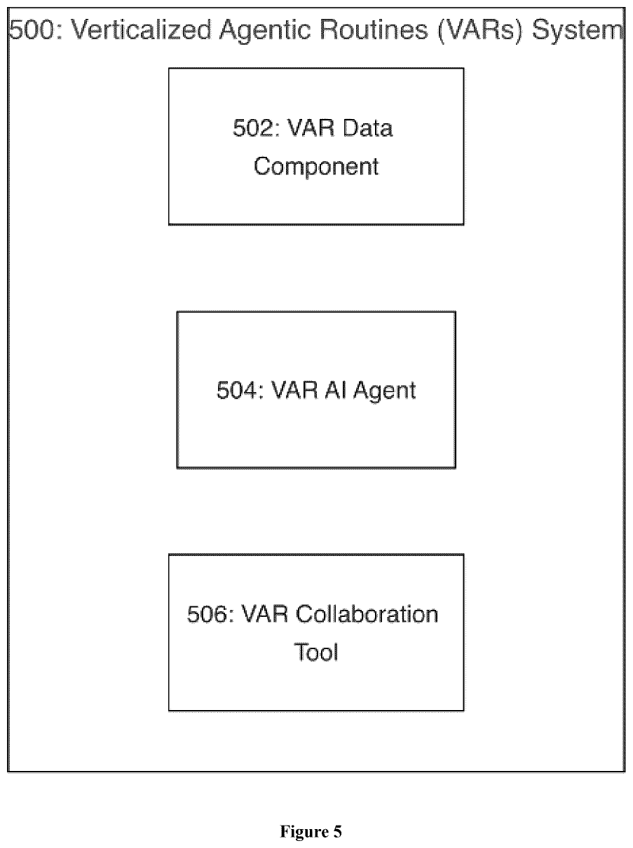

FIG. 5 illustrates the VAR system 500 comprising, VAR Data Component 502, VAR AI Agent 504 and VAR Collaboration tool 506. The VAR Data component 502 may serve as an element in the Verticalized Agentic Routines (VARs) system. This component may integrate a multitude of industry data sources, thereby ensuring that insights are both accurate and context-aware. The integration process may be facilitated by proprietary data models, which may enhance the data integration and prediction accuracy. Additionally, knowledge graphs may be employed to facilitate semantic understanding and relationship mapping, allowing for a more comprehensive interpretation of the integrated data.

The VAR Data Component 502 may deliver improved prediction accuracy compared to industry-specific baseline forecasts. This enhancement may be achieved through the use of AI/ML based predictions, which may generate outputs that are leveraged by AI agents to perform adjustments mimicking human behavior. Large language model (LLM) embeddings may further enhance the component's ability to process and understand natural language inputs, including instructions, queries, and unstructured data.

The component may also enable semantic understanding and relationship mapping of the integrated industry data sources, which may be crucial for optimizing industry workflows. This capability may be supported by the knowledge graphs, which empower AI agents to infer, reason, and act efficiently. The VAR Data Component 502 may ensure adaptability, scalability, and high performance of the optimized industry workflows, thereby contributing to the overall efficacy of the VARs system.

In summary, the VAR Data Component 502 may play a significant role in the VARs system by integrating industry data sources, enhancing prediction accuracy, and enabling semantic understanding and relationship mapping. These capabilities may collectively optimize industry workflows and improve performance, ensuring that the system remains adaptable and scalable in dynamic operational environments.

The VAR AI Agent component 504 may optimize workflows and enable advanced insights within the VARs system. This component may utilize AI/ML based predictions to generate outputs that facilitate adjustments by the AI agent, potentially mimicking human behavior. The AI/ML based predictions may be employed to enhance the efficiency and outcomes of the agentic routines, which are modular, task-specific workflows designed for automation and optimization within specific industry verticals. The VAR AI Agent 504 may integrate a wide range of data sources, ensuring accurate and context-aware insights tailored to specific industry needs. This integration may be supported by proprietary data models and knowledge graphs, which enable semantic understanding and relationship mapping, empowering AI agents to infer, reason, and act efficiently. The VAR AI Agent 504 may also employ optimization techniques, such as reinforcement learning and gradient-based optimization, to continually improve routine efficiency and outcomes. Additionally, the VAR AI Agent 504 may enable advanced visibility, actionable insights, and automated response mechanisms for the optimized industry workflows. This may include real-time monitoring, predictive analytics, anomaly detection, and automated routine workflows, which respond to identified insights by triggering predefined actions or generating recommendations for human review. The VAR AI Agent may ensure adaptability, scalability, and high performance of the optimized industry workflows, potentially improving efficiency, performance, and decision-making.

The VAR Collaboration Tool 506 may facilitate user collaboration and communication within the Verticalized Agentic Routines (VARs) system. This component may include the Agentic Routine Builder and the agent-to-agent collaboration framework, which may be integral to its functionality. The Agentic Routine Builder may allow non-technical users to build, share, refine, and scale industry-specific routines, thereby empowering users and fostering collaboration. This capability may be crucial for enabling seamless communication and coordination across multi-tier supply chain entities, as facilitated by the agent-to-agent collaboration framework. The framework may enhance network harmonization and performance by using shared context, hierarchical planning, and chain of thought. The VAR Collaboration Tool may thus play a pivotal role in improving supply chain efficiency and ensuring adaptability and scalability within the VARs system. The integration of these sub-components may ensure that the VAR Collaboration Tool can effectively support the optimization of workflows in specific industries.

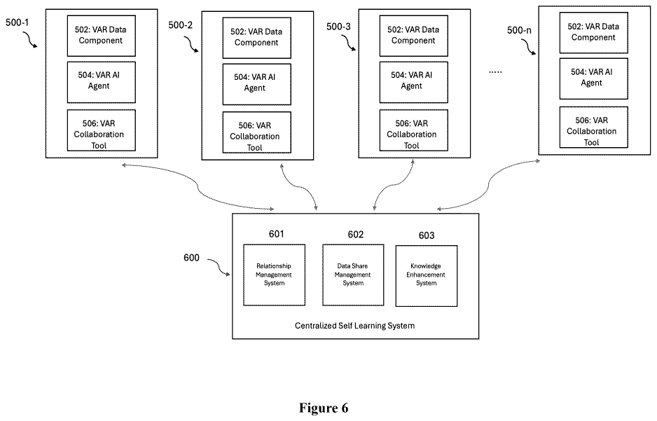

FIG. 6 illustrates a block diagram of a plurality of VAR systems (500-1, 500-2, 500-3, 500-n) connected to a Centralized Self Learning System (600). Wherein, “n” is an integer great than one (1). Each VAR system shown in FIG. 6 is similar to the one discussed in FIG. 5, wherein the VAR system comprises a VAR Data Component 502, a VAR AI Agent 504, and a VAR Collaboration Tool 506 as detailed above. These components collectively enable the integration of industry data, the generation of AI-driven insights, and the facilitation of collaboration across multiple instances, thereby optimizing workflows in various industries.

Each VAR system 500 (500-1 to 500-n) will be capable of opting-in to connect with the centralized learning system 600 such that one or more VAR systems may be connected to the CLS 600 at any given time. When connected to the CLS system 600, data transmitted by the VAR system 500 to the CLS 600 will be sanitized prior to the transmission such that confidential data is removed from the data transmitted to the CLS 600.

The Centralized Self Learning System 600 comprises three sub-components: the Relationship Management System (RMS) 601, the Data Share Management System (DMS) 602, and the Knowledge Enhancement System (KES) 603. Wherein, the Relationship Management System 601 creates knowledge graphs based on information shared by each VAR system (500-1 to 500-n), while the Data Share Management System 602 controls and manages the sharing of data between different VAR instances based on various parameters. That is, in order to enable network effect, fine grained control of information is kept for data that is shared between the various VAR systems (500-1 to 500-n). And, finally, the Knowledge Enhancement System 603 leverages the other two systems—RMS 601 and DMS 602—to extend the intelligence of individual VAR systems (500-1 to 500-n). Thereby, resulting in the KES 603 becoming incrementally smarter as more VAR systems (500-1 to 500-n) opt-in for connection. This self-learning systems ensures that the VAR systems (500-1 to 500-n) and the CSLS 600 can continuously learn and improve, maintaining adaptability, scalability, and high performance in dynamic operational environments.

The inventive concepts disclosed herein as to the Verticalized Agentic Routines (VARs) systems (500-1 to 500-n), the CSLS 600 and their related functionalities can be executed on computer implemented device such as computers, smart phones, tablets, data capture systems, mobile telecommunications networks, clouds, servers, or the like. The execution of the functionalities of the VAR systems (500-1 to 500-n) and the CSLS 600 may be achieved by executing computer readable instructions stored on a memory by one or more processors. The memory may be a non-transitory, computer-readable storage apparatus and/or medium having a plurality of computer readable instructions or code stored thereon. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. And as used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C #, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

As used herein, the singular forms “a”, “an”, and “the” include plural referents unless the context clearly dictates otherwise. Thus, for example, reference to a “body” includes aspects having two or more bodies unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Although several aspects of the disclosure have been disclosed in the foregoing specification, it is understood by those skilled in the art that many modifications and other aspects of the disclosure will come to mind to which the disclosure pertains, having the benefit of the teaching presented in the foregoing description and associated drawings. It is thus understood that the disclosure is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described disclosure

What is claimed is:

1. A computer-implemented method for optimizing workflows in an industry, the method comprising:
integrating, by a Verticalized Agentic Routines (VAR) data component, a plurality of industry data sources to ensure accurate and context-aware insights;
enabling, by the VAR data component, semantic understanding and relationship mapping of the integrated industry data sources;
delivering, by the VAR data component, improved prediction accuracy compared to industry-specific baseline forecasts;
optimizing, by a VAR AI agent, industry workflows based on the accurate and context-aware insights provided by the VAR data component;
enabling, by the VAR AI agent, advanced visibility, actionable insights, and automated response mechanisms for the optimized industry workflows; and
ensuring, by the VAR, adaptability, scalability, and industry-leading performance of the optimized industry workflows.

2. The method of claim 1, wherein the VAR data component leverages proprietary data models, knowledge graphs, AI/ML based predictions, and large language model (LLM) embeddings.

3. The method of claim 2, wherein the AI/ML based predictions generate outputs that are leveraged by the VAR AI agent to perform adjustments mimicking human behavior.

4. The method of claim 1, wherein the VAR data component enhances ability of the VAR AI agent to process and understand natural language inputs, including instructions, queries, and unstructured data.

5. The method of claim 1, wherein the VAR AI agent improves efficiency, performance, and decision-making for the optimized industry workflows.

6. The method of claim 1, further comprising:
allowing, by a VAR collaboration tool, non-technical users to build, share, refine, and scale industry-specific routines; and
enabling, by the VAR collaboration tool, seamless communication and coordination across multi-tier supply chain entities.

7. The method of claim 6, wherein the VAR collaboration tool comprises an Agentic Routine Builder, which is a user-friendly tool for building, sharing, refining, and scaling industry-specific routines.

8. The method of claim 6, wherein the VAR collaboration tool comprises an agent-to-agent collaboration framework that uses shared context, hierarchical planning, and chain of thought, and is proprietary and secure.

9. The method of claim 6, wherein the VAR collaboration tool fosters collaboration, improves supply chain efficiency, and enhances network harmonization and performance.

10. The method of claim 1, wherein the VAR optimizes workflows in at least one of the following industries: supply chain, automotive, manufacturing, or logistics.

11. The method of claim 1, wherein the VAR AI agent enables at least one of real-time monitoring, predictive analytics, anomaly detection, or automated routine workflows for the optimized industry workflows.

12. A Verticalized Agentic Routines (VARs) system for optimizing workflows in a specific industry, the system comprising:
a VAR data component configured to:
integrate a plurality of industry data sources to ensure accurate and context-aware insights,
enable semantic understanding and relationship mapping of the integrated industry data sources, and
deliver improved prediction accuracy compared to industry-specific baseline forecasts;
a VAR AI agent configured to:
optimize industry workflows based on the accurate and context-aware insights provided by the VAR data component, and
enable advanced visibility, actionable insights, and automated response mechanisms for the optimized industry workflows; and
a VAR collaboration tool configured to:
allow non-technical users to build, share, refine, and scale industry-specific routines, and
enable seamless communication and coordination across multi-tier supply chain entities;
wherein the VAR system ensures adaptability, scalability, and industry-leading performance of the optimized industry workflows.

13. The system of claim 12, wherein the VAR data component leverages proprietary data models, knowledge graphs, AI/ML based predictions, and large language model (LLM) embeddings.

14. The system of claim 12, wherein the AI/ML based predictions generate outputs that are leveraged by the VAR AI agent to perform adjustments mimicking human behavior.

15. The system of claim 12, wherein the VAR data component enhances the ability of the VAR AI agent to process and understand natural language inputs, including instructions, queries, and unstructured data.

16. The system of claim 12, wherein the VAR AI agent improves efficiency, performance, and decision-making for the optimized industry workflows.

17. The system of claim 12, wherein the VAR collaboration tool comprises an Agentic Routine Builder, which is a user-friendly tool for building, sharing, refining, and scaling industry-specific routines.

18. The system of claim 12, wherein the VAR collaboration tool comprises an agent-to-agent collaboration framework that uses shared context, hierarchical planning, and chain of thought, and is proprietary and secure.

19. The system of claim 12, wherein the VAR collaboration tool fosters collaboration, improves supply chain efficiency, and enhances network harmonization and performance.

20. The system of claim 12, wherein the VAR system optimizes workflows in at least one of the following industries: supply chain, automotive, manufacturing, or logistics.
